(19) United States
(12) Patent Application Publication
(10) Pub. No.: US 2015/0035400 A1
(43) Pub. Date: Feb. 5, 2015

(54) MOTOR APPARATUS INCLUDING MOTOR FIXED TO HOUSING BY FLANGE BEING PROTRUDED IN MOTOR AXIAL DIRECTION

(71) Applicants: DENSO CORPORATION, Kariya-city (JP); Advics Co., Ltd., Kariya-city (JP)

(72) Inventor: Fumitoshi KOYAMA, Kariya-shi (JP)

(21) Appl. No.: 14/445,592

(22) Filed: Jul. 29, 2014

(30) Foreign Application Priority Data
Jul. 30, 2013 (JP) 2013-157724
Sep. 3, 2013 (JP) 2013-182414

(51) Int. Cl. H02K 5/04

(52) U.S. Cl. CPC H02K 5/04; H02K 2205/00
USPC 310/89

(57) ABSTRACT

The motor apparatus includes a motor and a housing to which the motor is fixed. The motor includes a yoke having a bottomed-cylindrical shape, a flange being protruded from the opening end of the yoke towards an anti-bottom end side of the yoke. The housing includes a yoke-mounted surface, to which the opening end of the yoke comes into contact and a flange-mounted surface, to which the flange comes into contact. Further, the motor apparatus includes a rigid coupling portion that rigidly couples the housing to the motor and prevents the housing and the motor from relatively moving in the axial direction.

### CROSS-REFERENCE TO RELATED APPLICATION

This application is based on and claims the benefit of priority from earlier Japanese Patent Application Nos. 2013-157724 filed Jul. 30, 2013 and 2013-182414 filed Sep. 3, 2013, the description of which is incorporated herein by reference.

### BACKGROUND

1. Technical Field

The present disclosure relates to a motor apparatus including a motor fixed to a housing of the motor apparatus.

2. Description of the Related Art

As an example of the motor apparatus, Japanese Patent No. 4755707 discloses a motor apparatus including a motor fixed to a housing of the motor apparatus by a screw. Specifically, the motor apparatus disclosed by the above-described patent document includes a flange portion disposed at an opening end of the yoke in the motor. The flange portion protrudes radially outward from the motor and includes a through hole through which the screw is penetrated. The motor is fixed to the housing by the screw that penetrates the through hole while the opening end of the yoke and the flange portion come into contact with a surface of the housing which has a roughly rectangular parallelopiped shape.

Moreover, a motor apparatus fixed to the housing by a calking has been also known.

However, according to a conventionally used motor apparatus, a surface to which the opening end of the yoke comes into contact (yoke-mounted surface) and a surface to which the flange portion comes into contact (flange-mounted surface) are formed on the same surface. In this respect, based on a requirement to enhance the performance of the motor, if the outer diameter of the motor is required to be extended while the size of the housing is left unchanged, the area used for mounting the flange-mounted surface is restricted. Therefore, the outer diameter of the motor cannot be extended easily.

### SUMMARY

An embodiment provides a motor apparatus capable of extending the outer diameter of the motor without expanding the size of the housing thereof.

As a first aspect of the embodiment, the motor apparatus includes a motor and a housing to which the motor is fixed. The motor includes a yoke having a bottomed-cylindrical shape, a flange being protruded from the opening end of the yoke towards an anti-bottom end side of the yoke. The housing includes a yoke-mounted surface, to which the opening end of the yoke comes into contact and a flange-mounted surface, to which the flange comes into contact. Further, the motor apparatus includes a rigid coupling portion that rigidly couples the housing to the motor and prevents the housing and the motor from relatively moving in the axial direction.

According to the above-described motor apparatus, since the yoke-mounted surface and the flange-mounted surface can be formed on different surfaces of the housing, the outer diameter of the motor can readily be extended without expanding the size of the housing thereof.

### BRIEF DESCRIPTION OF THE DRAWINGS

In the accompanying drawings:

FIG. 1 is a diagram showing a front view of the motor apparatus according to the first embodiment of the present disclosure;

FIG. 2 is an exploded view of the motor apparatus;

FIG. 3 is a diagram showing a right-side view of FIG. 1;

FIG. 4 is a cross sectional view sectioned at A-A line in FIG. 1;

FIG. 5 is a cross sectional view sectioned at B-B line in FIG. 4;

FIG. 6 is a cross sectional view showing a major portion in the modification of the first embodiment;

FIG. 7 is a front view of the motor apparatus according to the second embodiment of the present disclosure;

FIG. 8 is a front view showing a major portion of the yoke in FIG. 6; and

FIG. 9 is a cross sectional view sectioned at C-C line in FIG. 6.

### DETAILED DESCRIPTION OF THE PREFERRED EMBODIMENTS

With reference to the drawings, embodiment of present disclosure is described as follows. In the respective embodiments, the same reference number is applied to portions identical or equivalent from each other in the drawings.

### First Embodiment

Hereinafter, the first embodiment of the present disclosure is described.

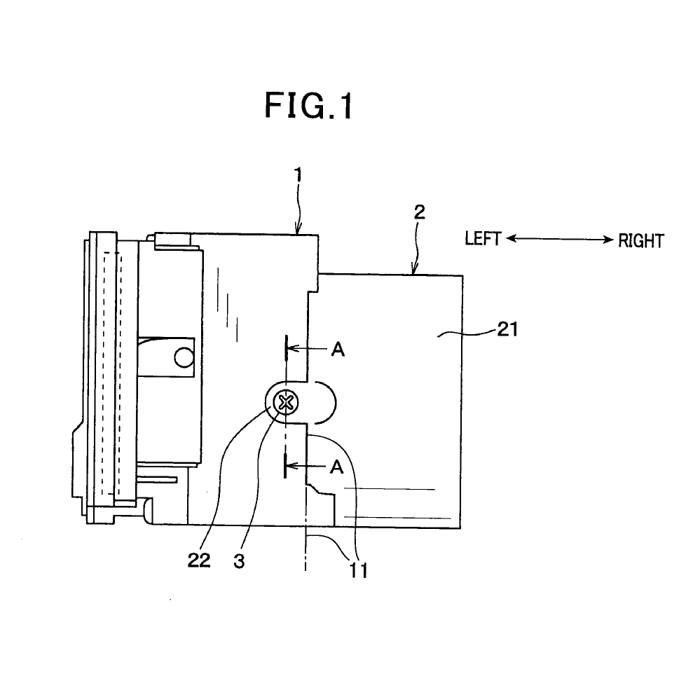

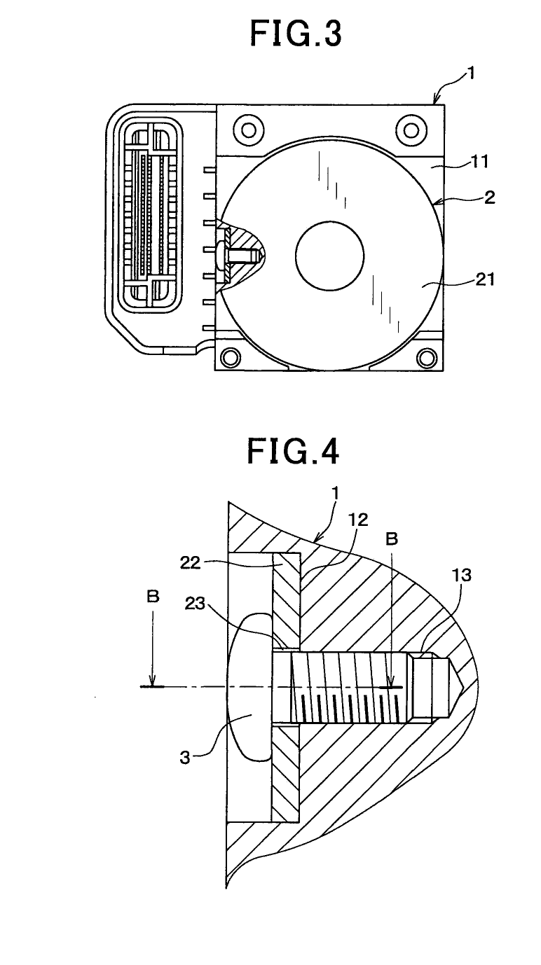

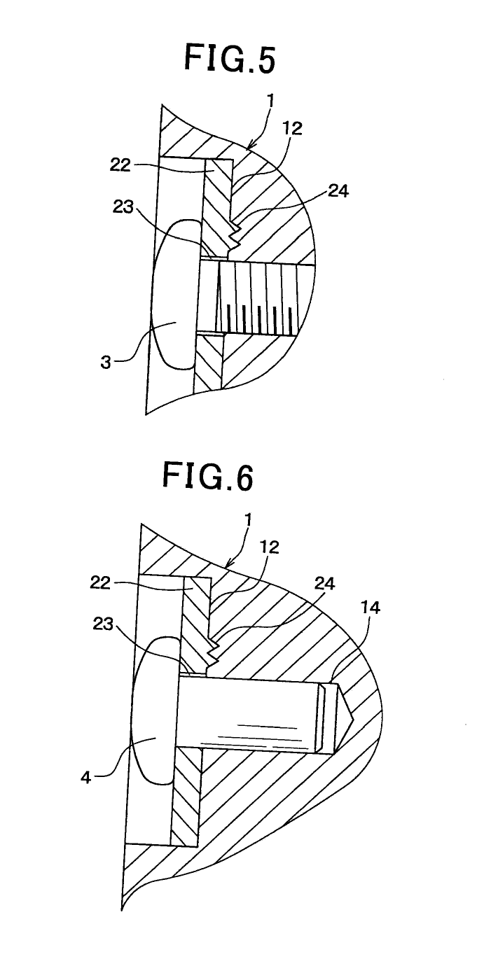

FIGS. 1 to 5 illustrate a motor apparatus adapted for a brake fluid pressure control unit which is an actuator for controlling the brake fluid pressure in a vehicle. The brake fluid pressure control unit includes housing 1, a pump (not shown) that pressurizes the brake fluid, motor 2 that drives the pump, a plurality of electromagnetic valves 50 that opens/ closes the brake fluid passage through which the brake fluid flows, an electronic control unit 60 that controls the motor 2 and the electromagnetic valves.

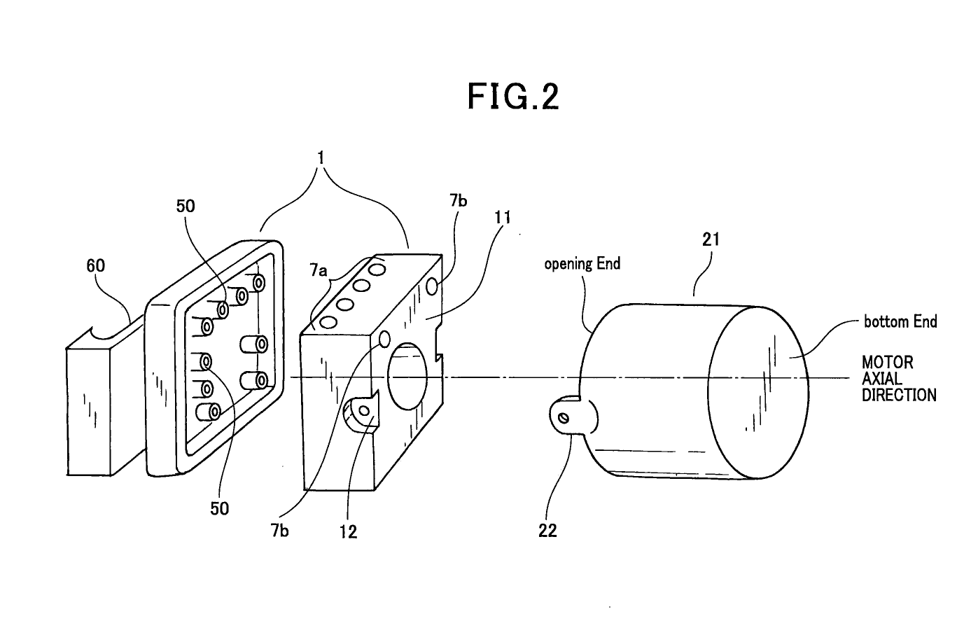

As shown in FIG. 2, the housing 1 is made of aluminum alloy having a roughly rectangular parallelepiped shape and includes plenty of brake fluid passages that allow the brake fluid to flow. On the surface of the housing 1, 6 ports communicating with the brake fluid passages are formed. Further, 4 ports 7a among the 6 ports are connected to respective wheel cylinders corresponding to the 4 wheels in the vehicle and 2 ports 7b are connected to the master cylinder in the vehicle.

The housing 1 is provided with a pump chamber having a cylindrical-hole shape in which one end thereof is opened and the other end is closed. The pump chamber includes a pump therein and extends in the horizontal direction.

As shown in FIG. 2, the housing 1 includes a flat yoke-mounted surface 11 to which the opening end of the yoke 21 comes into contact (described later) and a flat flange-mounted surface 12 to which the flange 22 comes into contact (described later). The yoke-mounted surface 11 and the flange-mounted surface 12 are formed on the side wall surface of the housing 1. More specifically, the flange-mounted surface 12 is formed on both side wall surfaces of the surface on which the yoke-mounted surface 11 is formed.

In the housing 1, female screw thread 13 is formed on the flange-mounted surface 12 to be attached to screw 3 (described later).

The motor 2 includes the rotational shaft being extended in the horizontal direction such that the one end of the rotational shaft is extended to the pump chamber to be coupled to the pump, thereby driving the pump. It is noted that the direction where the rotational shaft of the motor 2 is extended is defined as a motor axial direction (i.e., axial direction).

The motor 2 includes yoke 21 having bottomed cylindrical shape made of iron-based metal with ferromagnetic properties. The yoke 21 has an opening end section and a bottom end section at respective ends of the bottomed cylinder in the motor axial direction. The opening-end section of the yoke 21 is illustrated in the left side of FIG. 1 and the bottom end section of the yoke 21 is illustrated in the right side of FIG. 1. Also, the opening-end section and the bottom end section is illustrated in FIG. 2.

The yoke 21 includes flange 22 having flat plate shape integrated thereto such that the flange 22 protrudes from the opening-end section of the yoke 21 towards an anti-bottom portion side of the yoke 21. Specifically, the flange 22 protrudes directly from the opening-end section of the yoke 21. More specifically, the flange 22 is formed at the opening-end section of the yoke 21 to be extended therefrom. In other words, the flange 22 is arranged on an extended line of the cylindrical portion of the yoke 21. Hence, when viewing the motor 2 from along the motor axial direction, the flange 22 is located within the projecting plane of the yoke 21.

The flange 22 is located at two portions to be shifted from each other by 180 degree in the circumference direction of the yoke 21. Also, through hole 23 is formed at the flange 22. Moreover, the flange 22 includes a projection 24 including a plurality of projections arranged on a surface that faces the flange-mounted surface 12.

Then, the motor 2 is fixed to the housing 1 by having the opening-end section of the yoke 21 come into contact with the yoke-mounted surface 11 and having the flange 22 come into contact with the flange-mounted surface 12 so as to screw the screw 3 into the female screw thread 13.

At this point, the flange 22 is press-contacted to the flange-mounted surface 12 by tightening the screw 3 so that the projection 24 bites into the flange-mounted surface 12. Then, since the flange 22 is rigidly coupled to the flange-mounted surface, the yoke 21 is prevented from moving towards the motor axial direction with respect to the housing 1. That is, the housing 1 and the motor 2 are prevented from relatively moving in the motor axial direction. The motor 2 and the housing 1 are likely to move in the motor axial direction because of vibration of the motor or vibration caused by the vehicle running. It is noted that the screw 3 and the projection 24 correspond to the rigid coupling portion.

According to the first embodiment, the housing 1 and the motor 2 are rigidly coupled by using the flange 22 which protrudes towards the anti-bottom portion of the yoke 21 from the opening-end section of the yoke 21. Therefore, the yoke-mounted surface 11 and the flange-mounted surface 12 can be formed on different surfaces of the housing 1. As a result, the area used for mounting the flange-mounted surface can readily be secured so that the outer diameter of the motor can be extended easily without expanding the size of the housing 1.

According to the above-described embodiment, the housing 1 and the motor 2 are coupled by the screw 3. However, as shown in FIG. 6 (modification), the housing 1 and the motor 2 can be coupled by putting the rivet 4 into the hole 14 (e.g., press-fitting) formed on the flange-mounted surface 12 of the housing 1. In this case, the rivet 4 and the projection 24 correspond to the rigid coupling portion.

According to the above-described embodiment, the projection 24 is formed on the flange 22 having hardness higher than the housing 1. However, the projection is formed on the flange-mounted surface 12 of the housing 1 when the hardness of the housing 1 is higher than that of the flange 22.

### Second Embodiment

The second embodiment of the present disclosure is described as follows. According to the second embodiment, a structure of the coupling between the housing 1 and the motor 2 is changed from the structure of the coupling described in the first embodiment. Hence, since other configurations in the second embodiment are identical to that of the first embodiment, only the configurations that differ from the first embodiment are described.

According to the second embodiment, the screw 3 and the projection 24 are not used in the configurations.

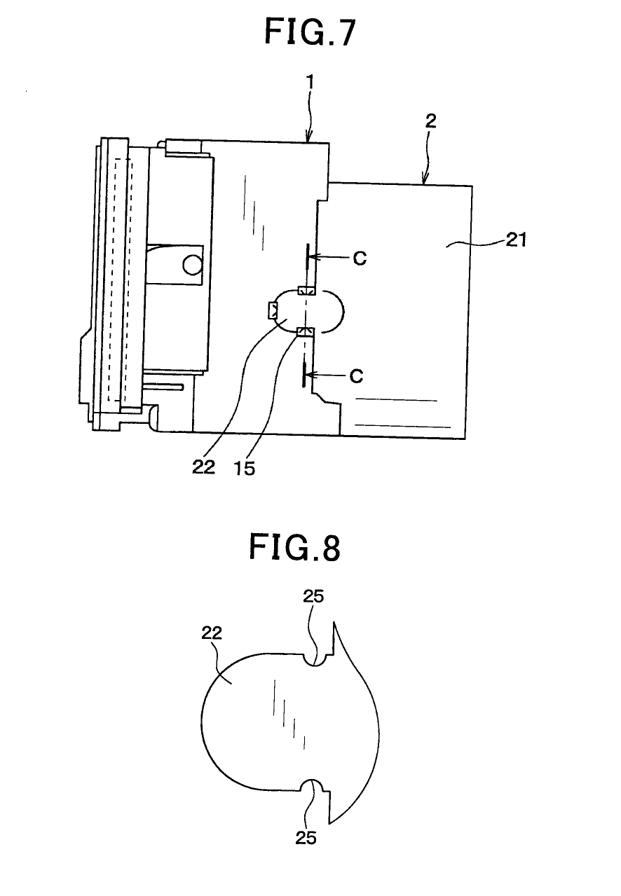

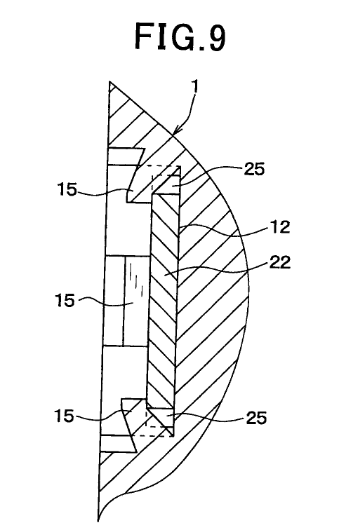

As shown in FIGS. 7 to 9, the flange 22 includes notches 25 at two portions on a surface extended in the motor axial direction.

Then, after having the opening-end section of the yoke 21 come into contact with the yoke-mounted surface 11 and the flange 22 come into contact with the flange-mounted surface 12, a periphery of the flange-mounted surface 12 of the housing 1 is caulked to make a caulking portion 15 which is plastic deformed, and the caulking portion 15 is engaged with the flange 22 so as to fix the motor 2 to the housing 1.

More specifically, the caulking portion 15 disposed at a portion corresponding to the notch 25 and a portion in the flange 22 which is furthest from the yoke 21.

In this regard, the caulking portion 15 corresponding to the notch 25 is engaged with the notch 25, whereby the yoke is avoided from shifting towards the motor axial direction with respect to the housing 1. In other words, the housing 1 and the motor 2 are prevented from relatively shifting in the motor axial direction. It is noted that the caulking portion 15 and the notch 25 correspond to the rigid coupling portion.

According to the second embodiment, similar advantages of the first embodiment can be obtained.

### Other Embodiment

According to the above-described embodiments, the housing 1 and the motor 2 are coupled by such as screw 3, however, the flange 22 can be bonded with the flange-mounted surface 12 by an adhesive as a rigid coupling portion so as to couple the housing 1 and the motor 2.

According to the above-described embodiments, the yoke 21 has a bottomed cylindrical shape, however, the yoke 21 can have an other shape such as bottomed polygonal pipe-shape.

The present disclosure is not limited to the above-described embodiments, however, various modification can be made within the scope of claims.

The above-described embodiments can be appropriately combined except when the combination is apparently unacceptable or there are no relations between the respective embodiment.

In the above-described embodiments, all elements constituting the embodiments are not necessarily used except when the element is designated as essential or the element is considered to be apparently essential in principle.

Moreover, in the above-described embodiments, when numeric values such as the number of elements, quantity and a range are mentioned for the elements in the embodiments, it is not limited to specific number of the numeric values except when the element is designated as essential or the element is apparently limited to specific number in principle.

Furthermore, in the above-described embodiment, when a shape and a positional relationship regarding the elements is mentioned, it is not limited to the shape and the positional relationship except when the element is designated as essential or the element is apparently limited to the specific shape and the positional relationship.

What is claimed is:

1. A motor apparatus comprising:
a housing;
a motor fixed to the housing, the motor having a rotational shaft extended in an axial direction thereof;
a yoke included in the motor, having a bottomed-cylindrical shape, the yoke including an opening end section and a bottom end section;
a flange included in the motor, the flange being protruded from the opening end section towards an anti-bottom end section side which is opposite side of the bottom end section in the axial direction;
a yoke-mounted surface included in the housing, to which the opening end section of the yoke comes into contact;
a flange-mounted surface included in the housing, to which the flange comes into contact; and
a rigid coupling portion that rigidly couples the housing to the motor and prevents the housing and the motor from relatively moving in the axial direction.

2. The motor apparatus according claim 1, wherein
the rigid coupling portion includes:
a screw being screwed to the housing to have the flange press-contacted with the flange-mounted surface; and
a projection formed on at least either of the flange and the flange-mounted surface, biting into the flange or the flange-mounted surface.

3. The motor apparatus according to claim 1, wherein
the rigid coupling portion includes:
a rivet being put into the housing to have the flange press-contacted with the flange-mounted surface; and
a projection formed on at least either the flange or the flange-mounted surface, biting into the flange or the flange-mounted surface.

4. The motor apparatus according to claim 1, wherein
the flange includes a notch;
the rigid coupling portion includes a caulking portion at which the housing is caulked to be deformed, the caulking portion being engaged with the notch.

5. The motor apparatus according to claim 1, wherein
the rigid coupling portion is an adhesive used to bond the flange to the flange-mounted portion.
